(19) United States
(12) Patent Application Publication
(10) Pub. No.: US 2026/0289727 A1
(43) Pub. Date: Sep. 24, 2026

(54) SUPER-RESOLUTION METHOD AND ELECTRONIC DEVICE

(71) Applicants: Hon Hai Precision Industry Co., Ltd., New Taipei City (TW); FOXCONN TECHNOLOGY GROUP CO., LTD, Shenzhen (CN)

(72) Inventors: Yi-Rong Lin, New Taipei City (TW); Kai-Lin Yang, New Taipei City (TW); Ming-Chien Hsu, New Taipei City (TW); Yung-Hui Li, New Taipei City (TW); Zhiwei Zhong, New Taipei City (TW); Shiqi Wang, New Taipei City (TW)

(73) Assignees: Hon Hai Precision Industry Co., Ltd., New Taipei City (TW); FOXCONN TECHNOLOGY GROUP CO., LTD, Shenzhen (CN)

(21) Appl. No.: 19/557,132

(22) Filed: Mar. 5, 2026

Related U.S. Application Data
(60) Provisional application No. 63/775,315, filed on Mar. 21, 2025.

(30) Foreign Application Priority Data
Dec. 29, 2025 (TW) 114151602

(51) Int. Cl. G06T 3/4053; G06T 3/4007; G06T 3/4046; G06T 5/50; G06T 5/60

(52) U.S. Cl. CPC G06T 3/4053; G06T 3/4007; G06T 3/4046; G06T 5/50; G06T 5/60; G06T 2207/10024; G06T 2207/10048; G06T 2207/20081; G06T 2207/20084; G06T 2207/20221

(57) ABSTRACT

The disclosure provides a super-resolution method and an electronic device. The method includes: obtaining an infrared image and a color image, wherein a resolution of the color image is greater than a resolution of the infrared image; performing upsampling on the infrared image to obtain an upsampled infrared image; concatenating the upsampled infrared image and the color image to serve as multiple channels of a fused image; inputting the fused image into a neural network to obtain a residual image; and generating an output infrared image according to the residual image and the upsampled infrared image.

### CROSS-REFERENCE TO RELATED APPLICATION

This application claims the priority benefit of U.S. provisional application Ser. No. 63/775,315, filed on Mar. 21, 2025 and Taiwan application serial no. 114151602, filed on Dec. 29, 2025. The entirety of each of the above-mentioned patent applications is hereby incorporated by reference herein and made a part of this specification.

### BACKGROUND

### Technical Field

The disclosure relates to a super-resolution method that combines an infrared image and a color image.

### Description of Related Art

In the field of autonomous vehicles, stable and accurate perception under variable environmental conditions (e.g., a low light source environment or harsh weather conditions) remains a major challenge. Traditional visible light image sensing systems are easily limited in the above environments, resulting in decreased perception accuracy, thereby affecting safety and reliability of autonomous driving systems.

In recent years, guided near-infrared (NIR) super-resolution (SR) technology has been regarded as a promising solution. This technology combines the complementary advantage of a near-infrared image and a visible light image to effectively improve image resolution and enhance visual perception capability under low illumination or harsh weather conditions. Through guided super-resolution processing, a system may generate a high-resolution image in the case of limited raw data, thereby improving accuracy of target identification and environmental understanding, which facilitates enhancement of perception robustness of an autonomous vehicle in a complex scenario. There is still room for improvement in conventional guided near-infrared super-resolution technology.

### SUMMARY

The disclosure provides a super-resolution method, performed by an electronic device. The super-resolution method includes the following steps. An infrared image and a color image are obtained. A resolution of the color image is greater than a resolution of the infrared image. Upsampling is performed on the infrared image to obtain an upsampled infrared image. A resolution of the upsampled infrared image is the same as the resolution of the color image. The upsampled infrared image and the color image are concatenated to form multiple channels of a fused image. The fused image is input into a neural network to obtain a residual image. A resolution of the residual image is the same as the resolution of the upsampled infrared image. An output infrared image is generated according to the residual image and the upsampled infrared image.

In an embodiment of the disclosure, the upsampling includes bicubic interpolation, and the neural network includes a gated convolution block.

In an embodiment of the disclosure, the super-resolution method further includes the following steps. Multiple training patch pairs are obtained during a training stage. Each of the training patch pairs includes an infrared patch and a color patch. A difference between the corresponding infrared patch and color patch is calculated for each training patch pair. A probability of sampling the training patch pairs is determined according to the difference to perform the training stage.

In an embodiment of the disclosure, the difference between the infrared patch and the color patch is positively correlated with the probability of sampling the training patch pairs.

In an embodiment of the disclosure, the step of determining the probability of sampling the training patch pairs according to the difference to perform the training stage includes the following steps. The training patch pairs are classified into multiple categories according to the difference, and a category difference of each of the categories is computed. A probability of selecting the categories is determined according to the category difference to determine a selected category. The corresponding training patch pairs are sampled from the selected category according to a strategy.

In an embodiment of the disclosure, the strategy is uniform sampling.

In an embodiment of the disclosure, the difference between the infrared patch and the color patch is a mean absolute error.

In an embodiment of the disclosure, the super-resolution method further includes the following step. A loss function is established during the training stage. The loss function includes a difference between a gradient of a real infrared image and a gradient of a predicted infrared image.

From another perspective, an embodiment of the disclosure provides an electronic device including a memory and a processor. The memory stores multiple commands. The processor is electrically connected to the memory and is used to execute the commands to perform the super-resolution method.

In the method and the electronic device, the infrared image and the color image are fused before entering the neural network. In addition, the training stage focuses on the more difficult-to-process patches, and the gradients are also added to the loss function to enhance edge features.

In order for the features and advantages of the disclosure to be more comprehensible, the following specific embodiments are described in detail in conjunction with the drawings.

### BRIEF DESCRIPTION OF THE DRAWINGS

FIG. 1 is a schematic diagram of an electronic device according to an embodiment.

FIG. 2 is a flowchart of an inference stage according to an embodiment.

FIG. 3 is a schematic diagram of an architecture of a neural network according to an embodiment.

FIG. 4 is a flowchart of a training stage according to an embodiment.

FIG. 5 is a schematic diagram of classifying training patch pairs according to an embodiment.

### DESCRIPTION OF THE EMBODIMENTS

Some embodiments of the disclosure will be described in detail with reference to the drawings. For the reference numerals cited in the following description, when the same reference numerals appear in different drawings, the reference numerals will be regarded as referring to the same or similar elements. The embodiments are only a part of the disclosure and do not disclose all possible implementations of the disclosure. More specifically, the embodiments are merely examples of a system and a method within the claims of the disclosure.

Terms such as “first” and “second” used herein do not particularly refer to an order or a sequence, and the terms are used only to distinguish elements or operations described with the same technical terms.

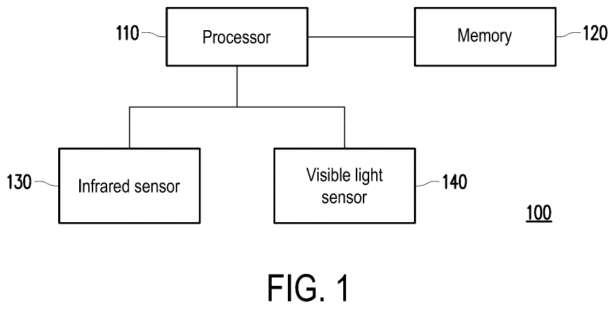

FIG. 1 is a schematic diagram of an electronic device according to an embodiment. Please refer to FIG. 1. An electronic device 100 may be implemented as an automotive system, a monitoring system, a personal computer, a server, or any electronic device with computing capabilities. The electronic device 100 includes a processor 110, a memory 120, an infrared sensor 130, and a visible light sensor 140. The processor 110 may include a central processor, a microprocessor, a microcontroller, a graphics processing unit (GPU), a deep-learning processing unit (DPU), a neural network processing unit (NPU), a tensor processing unit (TPU), an application specific integrated circuit (ASIC), or a programmable logic device (PLD). The memory 120 may include a random access memory, a read-only memory, a flash memory, a floppy disk, a hard disk, an optical disk, a USB flash drive, a magnetic tape, or a database accessible through the Internet, wherein multiple commands are stored. The processor 110 executes the commands to complete a super-resolution method. The infrared sensor 130 is used to sense electromagnetic waves in the infrared band to generate infrared images (near-infrared images, NIR). In some embodiments, the infrared images may also be regarded as thermal images. The visible light sensor 140 captures a color image, which, for example, includes red, green, and blue channels. The color image may also be referred to as an RGB image. The infrared sensor 130 and the visible light sensor 140 may include a charge-coupled device (CCD) sensor, a complementary metal-oxide semiconductor (CMOS) sensor, or other suitable photosensitive elements.

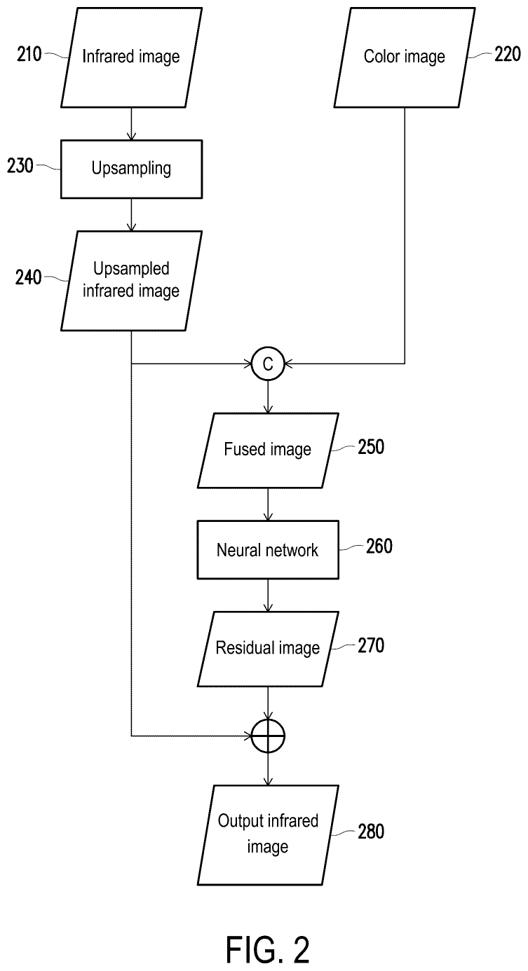

A super-resolution method is provided here to reconstruct a low-resolution infrared image by guiding using a high-resolution color image to generate an infrared image with a high resolution. FIG. 2 is a flowchart of an inference stage according to an embodiment. Please refer to FIG. 2. First, an infrared image 210 and a color image 220 are obtained. The resolution of the color image 220 is greater than the resolution of the infrared image 210. For example, the resolution of the infrared image 210 is H×W, and the resolution of the color image 220 is sH×sW, where H, W, and s are positive integers greater than 1. H represents the height, W represents the width, and s represents the multiplier, such as 2, 4, or 8. In this example, the infrared image 210 is a single-channel grayscale image, and the color image 220 includes three channels of red, green, and blue.

Next, upsampling 230 is performed on the infrared image 210 to obtain an upsampled infrared image 240. In some embodiments, upsampling 230 is bicubic interpolation, but in other embodiments, bilinear interpolation or other interpolation methods may also be included, and the disclosure is not limited thereto. After performing upsampling 230, the resolution of the upsampled infrared image 240 is the same as the resolution of the color image 220. Upsampling 230 may be expressed as Mathematical Expression 1 below.

$${L}^{↑} = Up ( L ) ∈ {ℝ}^{sH \times sW \times 1} \qquad [ Mathematical Expression 1 ]$$

where UP( ) represents upsampling 230, L represents the infrared image 210, and LT is the upsampled infrared image 240.

Next, the upsampled infrared image 240 and the color image 220 are concatenated to serve as multiple channels of a fused image 250. In the above example, the color image 220 has three channels, and the upsampled infrared image 240 has one channel, so the fused image 250 has a total of four channels. The size of the fused image 250 is sH×sW×4. The step of this fusion may be expressed as Mathematical Expression 2 below.

$${X}_{input} = Concat ( {L}^{↑} , G ) ∈ {ℝ}^{sH \times sW \times 4} \qquad [ Mathematical Expression 2 ]$$

where G represents the color image 220, Xᵢₙₚᵤₜ is the fused image 250, and Concat( ) is the concatenation operation.

The fused image 250 is input into at least one neural network 260 to obtain a residual image 270. The resolution of the residual image 270 is the same as the resolution of the color image, both being sH×sW. In this embodiment, the residual image 270 has one channel that includes infrared information. In some embodiments, the neural network 260 may include multiple gated convolution blocks, but in other embodiments, a U-net, a transformer, or other types of networks may also be included, and the disclosure is not limited thereto.

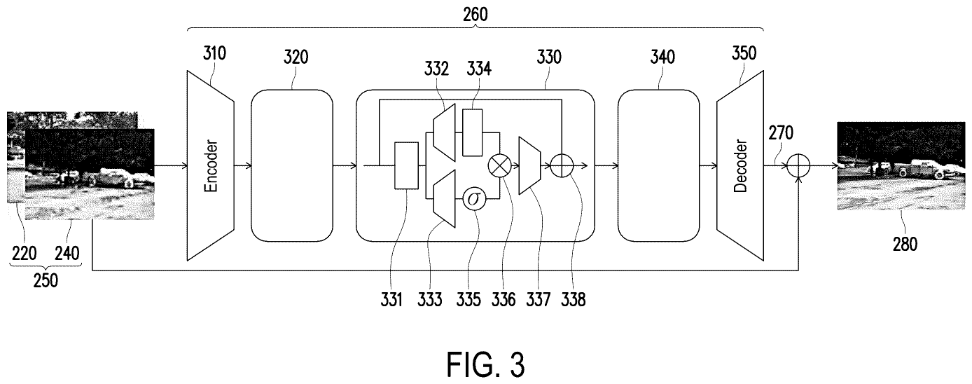

FIG. 3 is a schematic diagram of an architecture of a neural network according to an embodiment. Please refer to FIG. 3. In this embodiment, the neural network 260 includes an encoder 310, gated convolution blocks 320, 330, and 340, and a decoder 350. The encoder 310 is used to generate a feature map according to the fused image 250. The computation of the encoder 310 may be expressed as Mathematical Expression 3 below.

$${F}_{0} = {f}_{embed} ( {X}_{input} ) \qquad [ Mathematical Expression 3 ]$$

where f_{embed}( ) is the computation of the encoder 310 and F₀ is the feature map output by the encoder 310. The architectures of the gated convolution blocks 320, 330, and 340 are all the same. In some embodiments, each gated convolution block 320, 330, 340 includes at least one convolutional layer, a trainable gated function (e.g., a sigmoid function), and a residual layer. The gated convolution block 330 is taken as an example here for explanation. The gated convolution block 330 includes a normalization layer 331, linear layers 332 and 333, a convolutional layer 334, a gated function 335, a multiplication operation 336, a linear layer 337, and a residual layer 338. Generally speaking, the feature map first goes through the normalization layer 331 and is then divided into two branches. The two branches respectively include the linear layers 332 and 333. The first branch includes the convolutional layer 334, and the second branch includes the gated function 335. The two branches are merged by the multiplication operation 336 (element-wise multiplication). The merged feature map goes through the linear layer 337 and the residual layer 338 to obtain an output of the gated convolution block 330.

Following the last gated convolution block 340, the decoder 350 is used to generate the residual image 270 according to an output of the gated convolution block 340. Finally, an output infrared image 280 may be generated according to the residual image 270 and the upsampled infrared image 240. In this example, the residual image 270 is added to the upsampled infrared image 240 to obtain the output infrared image 280. This computation may be expressed as Mathematical Expression 4 below.

$${\hat{I}}_{HR} = {f}_{unembed} ( {F}_{fused} ) + {L}^{↑} \qquad [ Mathematical Expression 4 ]$$

where F_{fused} is the output of the last gated convolution block 340, f_{unembled}( ) represents the computation of the decoder 350, and Î_{HR} is the output infrared image 280 with a high resolution.

In this example, the gated convolution blocks 320, 330, and 340 effectively capture long-range dependencies and spatial context information, which facilitates reconstruction of infrared images. In this embodiment, the upsampled infrared image 240 and the color image 220 are concatenated before entering the neural network 260. Compared to other approaches that concatenate in the middle end or the back end of the neural network, this approach allows for early fusion of different information.

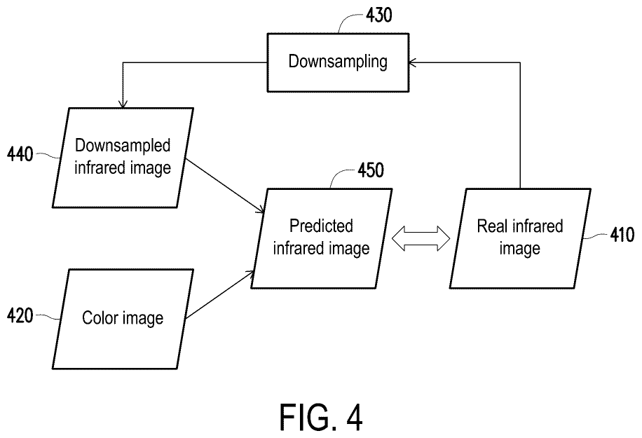

FIG. 4 is a flowchart of a training stage according to an embodiment. Please refer to FIG. 4. A high-resolution real infrared image 410 is used during the training stage. The real infrared image 410 undergoes downsampling 430 to obtain a downsampled infrared image 440. For example, the resolution of the real infrared image 410 is sH×sW, and the resolution of the downsampled infrared image 440 is H×W. On the other hand, a color image 420 is also obtained, and the resolution of the color image 420 is sH×sW. Next, the process of FIG. 2 is performed on the downsampled infrared image 440 and the color image 420 to obtain a predicted infrared image 450. The predicted infrared image 450 and the real infrared image 410 are substituted into a loss function to train parameters of the neural network 260.

In some embodiments, the color image 420 may be segmented to obtain multiple color patches based on hardware limitations. Similarly, the real infrared image 410 may also be segmented to obtain multiple infrared patches. The color patches respectively correspond to the infrared patches (such as having the same position), and the corresponding infrared patch and color patch form a training patch pair. The disclosure does not limit the size and the number of patches. In some embodiments, the size of the patch may also be the same as the size of the original image (i.e., without being segmented). In addition, the number of the real infrared images 410 and the color images 420 is greater than 1, so multiple training patch pairs may be generated even without segmentation.

Next, the training patch pairs are sampled to train the neural network 260. In some embodiments, a two-stage sampling strategy may be adopted. The strategy is also referred to as guided hierarchical sampling (GHS). During the initial stage, all the training patch pairs are uniformly sampled, and the neural network 260 is trained according to the obtained training patch pairs. During the second stage, more difficult training patch pairs are targeted for intensive training. Specifically, for each training patch pair, a difference between the corresponding infrared patch and color patch is computed. The difference is, for example, the mean absolute error, which may be expressed as Mathematical Expression 5 below.

$$D + \frac{1}{N} {\sum }_{i , j} \vert {‖ {G}_{color} ( i , j ) ‖}_{2} = {‖ {G}_{NIR} ( i , j ) ‖}_{2} \vert \qquad [ Mathematical Expression 5 ]$$

where G_{color} is the color patch, G_{NIR} is the infrared patch, (i,j) is the coordinate of a pixel in a patch, and N is a positive integer representing the number of pixels in a patch. In some embodiments, since the number of channels of the color patch and the number of channels of the infrared patch are different, 2-norm must be first computed and then subtracted. D represents the difference.

Next, the probability of sampling the training patch pair is determined according to the difference D to perform the training stage. In this embodiment, the difference D between the infrared patch and the color patch is positively correlated with the probability of sampling the training patch pair. In other words, the greater the difference D, the easier it is to sample the corresponding training patch pair. During this stage, the more difficult training patch pair is first sampled.

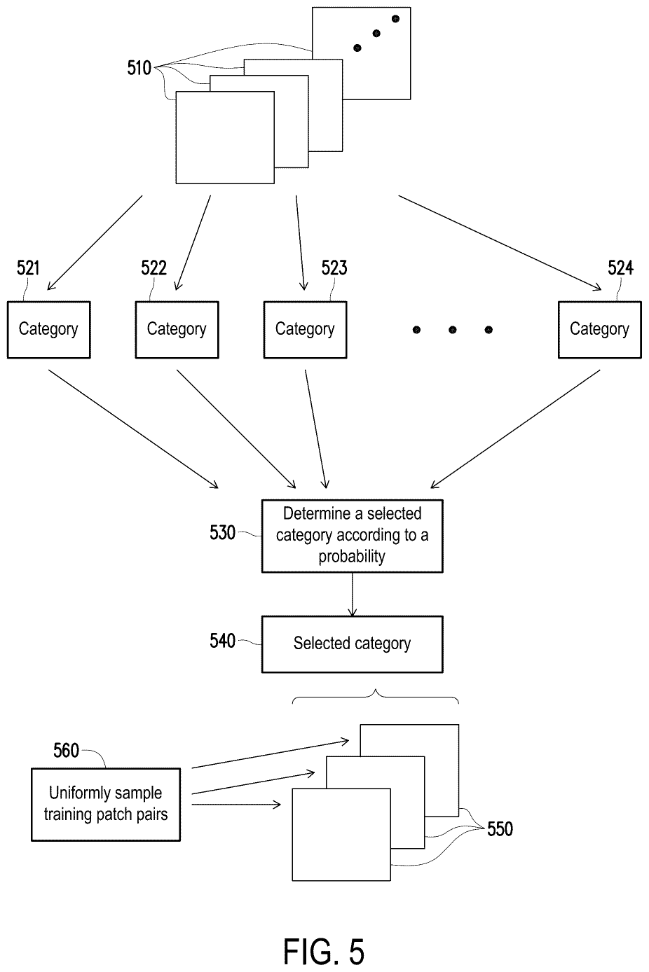

In some embodiments, the training patch pairs may also be first classified before sampling. FIG. 5 is a schematic diagram of classifying training patch pairs according to an embodiment. Please refer to FIG. 5. Here, multiple training patch pairs 510 are classified into multiple categories 521 to 524 according to the computed difference D. The number of the categories 521 to 524 may be 3, 5, 7, or any value. Each category has a value range of one difference. When the difference D falls within the value range, classification is performed on the corresponding category.

Next, a category difference of each category 521 to 524 is computed. For example, the mean of the differences D of all the training patch pairs in the same category is computed to serve as the category difference. Next, the probability of selecting the category is determined according to the category difference. Then, in step 530, a selected category 540 is determined according to the probability. For example, the category differences may be normalized, so that the sum is 1. After normalization, the category differences may serve as the probability. In other words, the greater the category difference, the greater the probability.

The selected category 540 includes multiple training patch pairs 550. Next, in step 560, one of the training patch pairs 550 is sampled from the selected category 540 according to a strategy. In some embodiments, the strategy is uniform sampling.

Here, the training patch pair 510 is sampled according to the difference D. However, the difference D is not necessarily very accurate and differences between multiple differences D may be large. For example, if a certain difference is very large (or very small), the probability of sampling will be too large (or too small). Therefore, in this embodiment, classification is first performed according to the difference D, and after classification, categories such as “difficult category” and “easy category” are generated. Then, sampling is performed according to the category difference, so as to increase the probability of selecting the “difficult category”. Next, uniform sampling is performed in the same category to prevent concentrated sampling of certain training patch pairs or neglect of certain training patch pairs due to an error of the difference D.

Please refer back to FIG. 4. The loss function is also established during the training stage. The objective is to make the predicted infrared image 450 as similar as possible to the real infrared image 410. In some embodiments, the loss function includes a difference between the predicted infrared image 450 and the real infrared image 410 and also includes a difference between the gradient of the real infrared image 410 and the gradient of the predicted infrared image 450. The loss function may be expressed as Mathematical Expression 6 below.

$${ℒ}_{total} = {‖ {\hat{I}}_{HR} - {I}_{GT} ‖}_{1} + λ \cdot {‖ ∇ {\hat{I}}_{HR} - ∇ {I}_{GT} ‖}_{1} \qquad [ Mathematical Expression 6 ]$$

where I_{GT} is the real infrared image 410, Î_{HR} is the predicted infrared image 450, A is a hyperparameter, and Lₜₒₜₐₗ is the loss. Through adding the difference between gradients, regions such as edges and textures in an image may be enhanced, which may solve the issue of blurry low-resolution infrared images.

The super-resolution method may be applied to an autonomous vehicle system. Through a low-resolution thermal image captured by the infrared sensor in conjunction with the color image captured by the visible light sensor, the high-resolution infrared image is reconstructed to facilitate the identification of a vehicle, a pedestrian, and a road obstacle ahead. The method may also be applied to smart monitoring and may be adapted to an environment under low light source or harsh weather conditions (e.g., fog, rain, and snow). Alternatively, the method may also be applied to industrial inspection, drone patrol, military reconnaissance, or disaster relief to reconstruct a high-resolution thermal image.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A super-resolution method, performed by an electronic device, the super-resolution method comprising:
obtaining an infrared image and a color image, wherein a resolution of the color image is greater than a resolution of the infrared image;
performing upsampling on the infrared image to obtain an upsampled infrared image, wherein a resolution of the upsampled infrared image is the same as the resolution of the color image;
concatenating the upsampled infrared image and the color image to serve as a plurality of channels of a fused image;
inputting the fused image into at least one neural network to obtain a residual image, wherein a resolution of the residual image is the same as the resolution of the upsampled infrared image; and
generating an output infrared image according to the residual image and the upsampled infrared image.

2. The super-resolution method according to claim 1, wherein the upsampling comprises bicubic interpolation, and the at least one neural network comprises a gated convolution block.

3. The super-resolution method according to claim 1, further comprising:
obtaining a plurality of training patch pairs during a training stage, wherein each of the training patch pairs comprises an infrared patch and a color patch;
computing a difference between the corresponding infrared patch and color patch for each of the training patch pairs; and
determining a probability of sampling the training patch pairs according to the difference to perform the training stage.

4. The super-resolution method according to claim 3, wherein the difference between the infrared patch and the color patch is positively correlated with the probability of sampling the training patch pairs.

5. The super-resolution method according to claim 3, wherein the step of determining the probability of sampling the training patch pairs according to the difference to perform the training stage comprises:
classifying the training patch pairs into a plurality of categories according to the difference, and computing a category difference of each of the categories;
determining a probability of selecting the categories according to the category difference to determine a selected category; and
sampling the corresponding training patch pairs from the selected category according to a strategy.

6. The super-resolution method according to claim 5, wherein the strategy is uniform sampling.

7. The super-resolution method according to claim 5, wherein the difference between the infrared patch and the color patch is a mean absolute error.

8. The super-resolution method according to claim 3, further comprising:
establishing a loss function during the training stage, wherein the loss function comprises a difference between a gradient of a real infrared image and a gradient of a predicted infrared image.

9. An electronic device, comprising:
a memory, storing a plurality of commands; and
a processor, electrically connected to the memory and used to execute the commands to perform a plurality of steps of:
obtaining an infrared image and a color image, wherein a resolution of the color image is greater than a resolution of the infrared image;
performing upsampling on the infrared image to obtain an upsampled infrared image, wherein a resolution of the upsampled infrared image is the same as the resolution of the color image;
concatenating the upsampled infrared image and the color image to serve as a plurality of channels of a fused image;
inputting the fused image into at least one neural network to obtain a residual image, wherein a resolution of the residual image is the same as the resolution of the upsampled infrared image; and
generating an output infrared image according to the residual image and the upsampled infrared image.

10. The electronic device according to claim 9, wherein the upsampling comprises bicubic interpolation, and the at least one neural network comprises a gated convolution block.

11. The electronic device according to claim 9, wherein the steps further comprise:
obtaining a plurality of training patch pairs during a training stage, wherein each of the training patch pairs comprises an infrared patch and a color patch;
computing a difference between the corresponding infrared patch and color patch for each of the training patch pairs; and
determining a probability of sampling the training patch pairs according to the difference to perform the training stage.

12. The electronic device according to claim 11, wherein the difference between the infrared patch and the color patch is positively correlated with the probability of sampling the training patch pairs.

13. The electronic device according to claim 11, wherein the step of determining the probability of sampling the training patch pairs according to the difference to perform the training stage comprises:
classifying the training patch pairs into a plurality of categories according to the difference, and computing a category difference of each of the categories;
determining a probability of selecting the categories according to the category difference to determine a selected category; and
sampling the corresponding training patch pairs from the selected category according to a strategy.

14. The electronic device according to claim 13, wherein the strategy is uniform sampling.

15. The electronic device according to claim 13, wherein the difference between the infrared patch and the color patch is a mean absolute error.

16. The electronic device according to claim 11, wherein the steps further comprise:
establishing a loss function during the training stage, wherein the loss function comprises a difference between a gradient of a real infrared image and a gradient of a predicted infrared image.
